(19) United States
(12) Patent Application Publication
(10) Pub. No.: US 2005/0256855 A1
(43) Pub. Date: Nov. 17, 2005

(54) Vacancy information search system

(75) Inventors: Shintaro Soma, Tokyo (JP); Hizuru Nawata, Tokyo (JP); Ken Kasagi, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 11/110,802

(22) Filed: Apr. 21, 2005

(30) Foreign Application Priority Data
Apr. 30, 2004 (JP) 2004-135208

(51) Int. Cl. G06F 17/30

(52) U.S. Cl. 707/3

(57) ABSTRACT

A vacancy information search system includes a vacancy information storage unit, reserved business entity storage unit, priority setting unit, and search unit. the vacancy information storage unit stores business entity vacancy information. The reserved business entity storage unit stores the log of a business entity reserved by a user. The priority setting unit sets a priority given by the user for the reserved business entity stored in the reserved business entity storage unit. The search unit accesses the vacancy information storage unit in response to a request from the user and searches for vacancy information of the reserved business entity of the user, which is stored in the reserved business entity storage unit, in order of priorities set for the reserved business entity. A vacancy information search method is also disclosed

### BACKGROUND OF THE INVENTION

The present invention relates to a business entity vacancy information search system and, more particularly, to a vacancy information search system which makes it possible to search for vacancy information of a business entity such as a restaurant, parking lot, karaoke room, or hotel from a terminal such as a cellular phone, PDA (Personal Digital Assistant), and personal computer having the Internet connection function.

Recent penetration of cellular phones and the like is remarkable, and most cellular phones have the Internet connection function. By timely acquiring various kinds of information from the cellular phones which are easy to carry, the users effectively utilize them in daily life.

For example, as a kind of Internet connection service, there is a system which displays a business entity list on the screen of a cellular phone and causes the user to select a desired business entity from the list and make a reservation after checking the vacancy information of the business entity (e.g., Japanese Patent Laid-Open No. 2002-318959). Various techniques are disclosed beside this as techniques using the Internet (e.g., Japanese Patent Laid-Open Nos. 2000-098537, 2003-099629, 2003-108839, and 2003-256712).

FIG. 4 shows the main functional arrangement of the vacancy information providing system disclosed in Japanese Patent Laid-Open No. 2002-318959. Referring to FIG. 4, reference numeral 10 denotes a center server; 20, Internet; 30, a business entity (franchisee) such as a restaurant, parking lot, karaoke room, or hotel; 40, a public telephone network; 50, a cellular phone network; 60, a base station; and 70, a cellular phone held by a user. A personal computer 31 or telephone set 32 is provided in the business entity 30.

The center server 10 comprises a mail processing unit 11, reservation processing unit 12, franchisee search unit 13, franchisee information registration unit 14, vacancy information notification (vacancy information notification DB) database 16, and franchisee database (franchisee DB) 17.

The franchisee DB 17 stores registration information of a business entity as a member of this system, including the business entity code, business entity user name, password, business entity category, business entity name, address, telephone number, mail address, nearest station, and profile of the business entity. If any change has occurred after registration of the franchisee, the registration information can be corrected from the personal computer 31 of the business entity 30 through the Internet 20 and franchisee information registration unit 14. The latest vacancy information of the business entity is uploaded from the personal computer 31 of the business entity 30 to the franchisee DB 17 through the Internet 20 and franchisee information registration unit 14.

[Business Entity Reservation]

In this system, to reserve a business entity, the user accesses the center server 10 through the Internet 20 by using the Internet connection function of the cellular phone 70 of his/her own. In response to the request from the user, the center server 10 sends a business entity category selection page to the cellular phone 70. When the user designates a desired business entity category on the screen of the cellular phone 70, the franchisee search unit 13 of the center server 10 accesses the franchisee DB 17 and sends a list of business entities (a list in which business entities are arranged in descending order of number of free spaces) of the designated category to the cellular phone 70. When the user selects a desired business entity from the business entity list, the franchisee search unit 13 of the center server 10 extracts the vacancy information of the selected business entity from the franchisee DB 17 and sends the extracted information to the cellular phone 70. The user determines whether to reserve the business entity with reference to the vacancy information of the desired business entity displayed on the screen of the cellular phone 70. If the user wants to reserve it, he/she calls the telephone set 32 of the business entity 30 from the cellular phone 70.

If the desired business entity has no free space, and the user absolutely wants to use the business entity, the vacancy information notification function of this system can be used. In this case, the user who wants notification of vacancy information selects “request vacancy mail” on the screen of the cellular phone 70.

Upon receiving this request, the center server 10 transmits a vacancy mail reservation page to the cellular phone 70. The user inputs the mail address of the cellular phone 70 of his/her own in the vacancy mail reservation page and selects “transmit”. The reservation processing unit 12 of the center server 10 receives the user's mail address, associates it with the business entity code of the business entity (desired business entity) desired by the user, and registers them in the vacancy information notification DB 16 as a vacancy mail transmission condition.

When the vacancy mail transmission condition is registered in the vacancy information notification DB 16, the mail processing unit 11 recognizes it. When the vacancy information of the desired business entity is uploaded to the franchisee DB 17, the mail processing unit 11 reads out the mail address from the vacancy information notification DB 16 and transmits e-mail which describes the vacancy information of the desired business entity to the mail address.

In the above-described conventional vacancy information providing system, business entities which are arranged in the list (detected business entities) strictly depend on the vacancy state at that instant. Hence, every time the user accesses the system, new business entities are listed at high probability, or business entities which are fairly unpopular and always have free spaces are detected.

Actually, people usually go to their favorite business entities and sometimes feel like trying a new business entity according to the mood. The favorite business entities are enjoying popularity in many cases and rarely win the top ranking in the business entity list.

In addition, business entities where people have visited once but never want to visit again (such business entities always have free spaces in many cases) also come in the business entity list. In the conventional system, the vacancy information of a desired business entity must be found in such a business entity list so that it takes long time and enormous effort to search for the vacancy information.

### SUMMARY OF THE INVENTION

It is a principal object of the present invention to provide a vacancy information search system capable of searching for vacancy information of a desired business entity easily in a short time.

In order to achieve the above object, according to the present invention, there is provided a vacancy information search system comprising vacancy information storage means for storing business entity vacancy information, reserved business entity storage means for storing a log of a business entity reserved by a user, priority setting means for setting a priority given by the user for the reserved business entity stored in the reserved business entity storage means, and search means for accessing the vacancy information storage means in response to a request from the user and searching for vacancy information of the reserved business entity of the user, which is stored in the reserved business entity storage means, in order of priorities set for the reserved business entity.

### BRIEF DESCRIPTION OF THE DRAWINGS

FIG. 1 is a view showing the main functional arrangement of a vacancy information search system according to an embodiment of the present invention;

FIGS. 2A to 2D are views showing changes in user information registration state in a dedicated storage area ensured in a user information DB in correspondence with a user code;

FIG. 3 is a functional block diagram of the main part of a center server in this system; and

FIG. 4 is a view showing the main functional arrangement of a conventional vacancy information providing system.

### DESCRIPTION OF THE PREFERRED EMBODIMENT

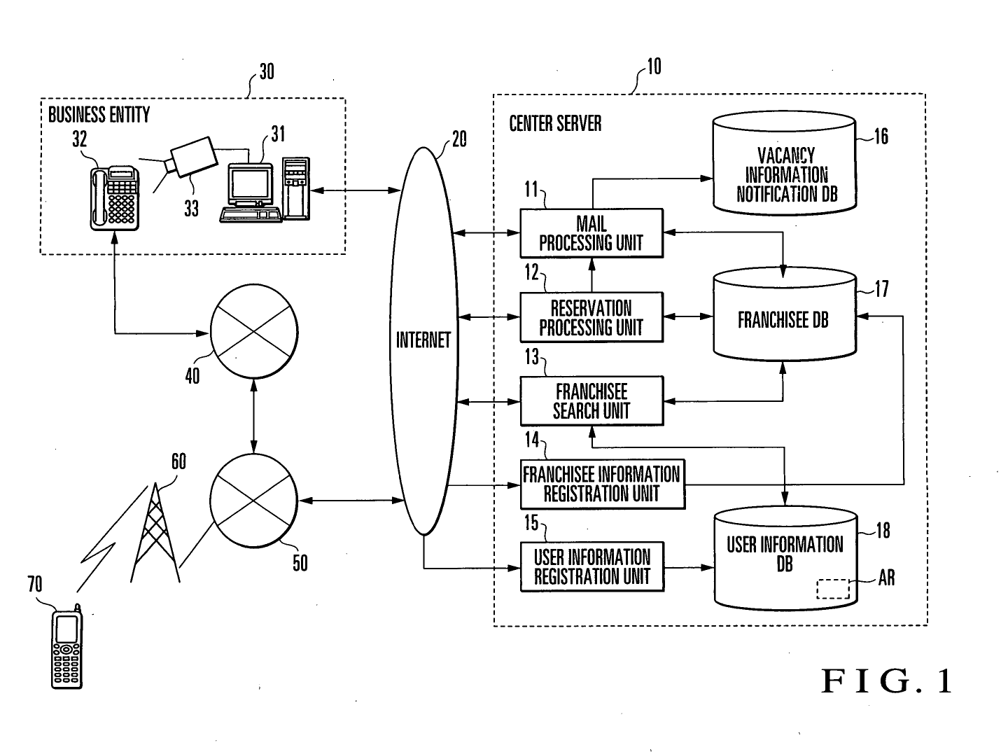

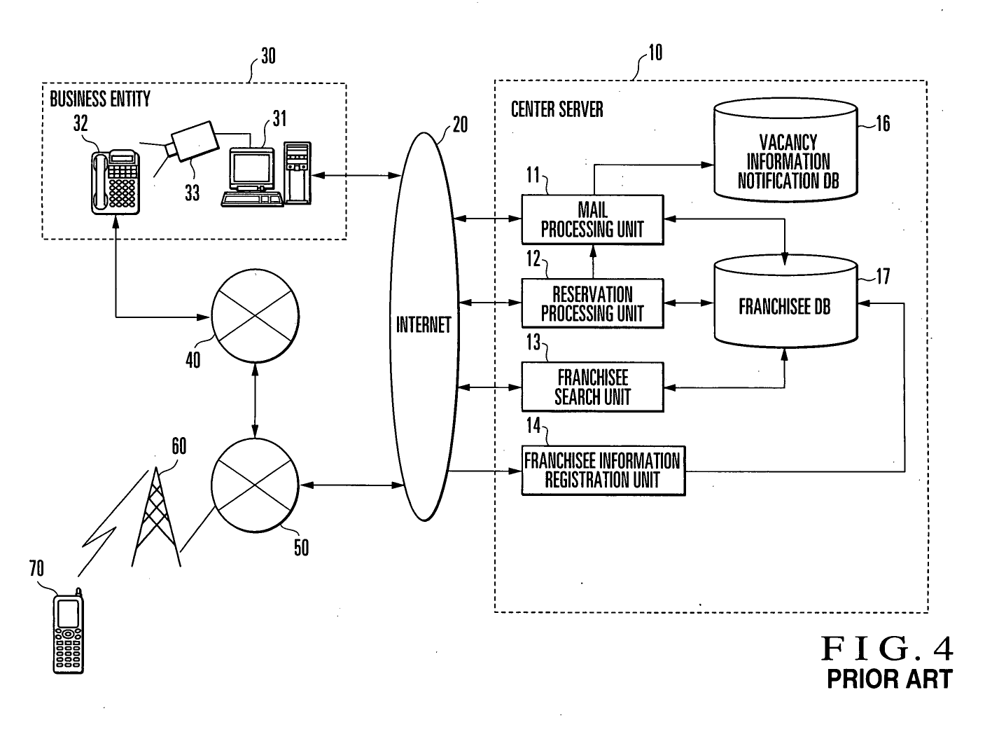

The present invention will be described below in detail with reference to the accompanying drawings. FIG. 1 shows a vacancy information search system according to an embodiment of the present invention. The same reference numerals as in FIG. 4 denote the same or similar constituent elements in FIG. 1, and a description thereof will be omitted.

In this embodiment, a user information registration unit 15 and user information database (user information DB) 18 are provided in a center server 10. In business entity search (to be described later) by a franchisee search unit 13, data (user information) stored in the user information DB 18 is referred to. In addition, a live camera 33 is installed in a business entity 30. In the business entity 30, the live camera 33 is connected to a personal computer 31. In the center server 10, the user information registration unit 15 stores, in the user information DB 18, user information given through Internet 20.

[User Registration]

In this system, the user executes user registration first. User registration is done in the following way.

The user accesses the user information registration unit 15 of the center server 10 from a cellular phone 70 of his/her own through a cellular phone network 50 and the Internet 20. The user inputs the user name, password, cellular phone mail address, and cellular phone number from the cellular phone 70 of his/her own.

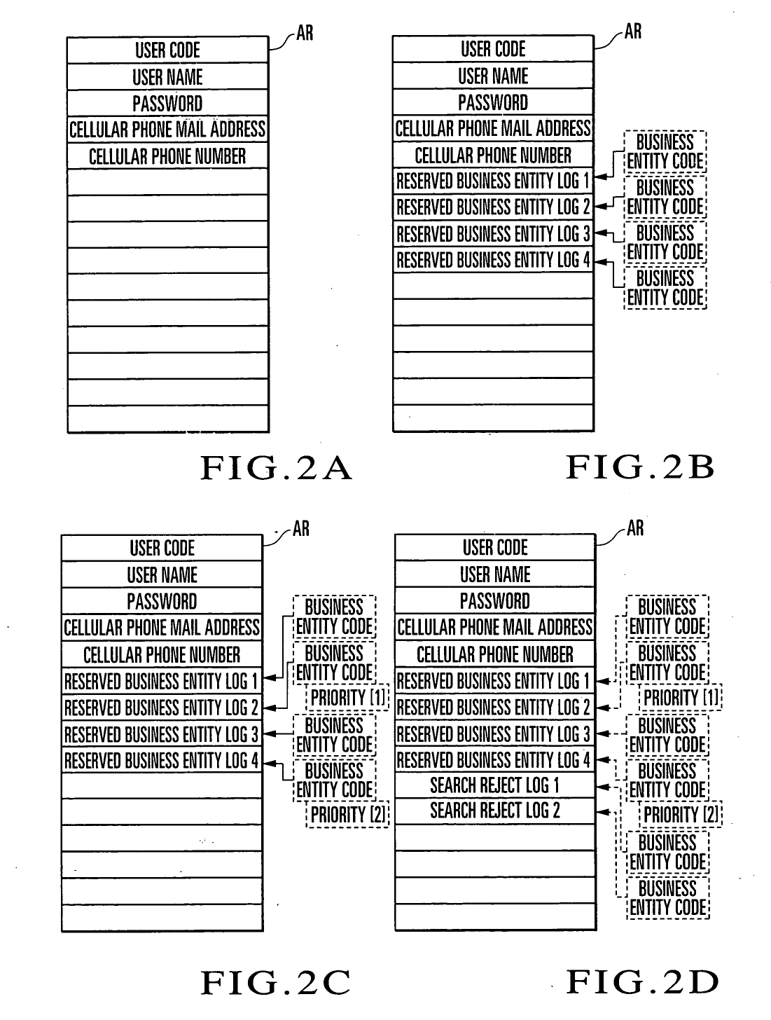

Upon receiving the user name, password, cellular phone mail address, and cellular phone number from the user, the user information registration unit 15 assigns a user code to the user, ensures a dedicated storage area AR in the user information DB 18 in correspondence with the user code, and registers the user name, password, cellular phone mail address, and cellular phone number of the user in the storage area AR (FIG. 2A).

[Business Entity Reservation: When No Reserved Business Entity is Present]

In this system, to reserve a business entity, the user accesses the center server 10 through the Internet 20 by using the Internet connection function of the cellular phone 70 of his/her own. Assume here that a user A has never reserved any business entity by using this system and is going to reserve one for the first time.

In response to the request from the user A, the center server 10 sends a business entity category selection page to the cellular phone 70. When the user A designates a desired business entity category on the screen of the cellular phone 70, a franchisee search unit 13 of the center server 10 accesses a franchisee DB 17 and sends a list of business entities (a list in which business entities are arranged in descending order of number of free spaces) of the designated category to the cellular phone 70.

When the user A selects a desired business entity from the business entity list, the franchisee search unit 13 of the center server 10 extracts the vacancy information of the selected business entity from the franchisee DB 17 and sends the extracted information to the cellular phone 70.

The user A determines whether to reserve the business entity with reference to the vacancy information of the desired business entity displayed on the screen of the cellular phone 70. If the user A wants to reserve it, he/she calls a telephone set 32 of the business entity 30 from the cellular phone 70.

When the reservation is made, the reservation information of the user A is sent from the personal computer 31 of the business entity 30 to the user information registration unit 15 of the center server 10 through the Internet 20. The user information registration unit 15 extracts the user code of the user A who has reserved the business entity 30 and the business entity code of the reserved business entity 30 from the reservation information sent from the business entity 30. The extracted business entity code is registered as “reserved business entity log 1 (reserved business entity 1)” in the storage area AR in the user information DB 18 specified by the extracted user code (FIG. 2B).

In a similar manner, every time the user A makes a reservation by using the system, the business entity code of the reserved business entity 30 is registered in the storage area AR in the user information DB 18 as “reserved business entity log (reserved business entity)”.

FIG. 2B shows a case in which the user A has reserved four business entities by this time, and the business entity codes of the reserved business entities are registered as “reserved business entity log 1 (reserved business entity 1)”, “reserved business entity log 2 (reserved business entity 2)”, “reserved business entity log 3 (reserved business entity 3)”, and “reserved business entity log 4 (reserved business entity 4)”.

[Priority Setting]

The user A can set priority for “reserved business entity log (reserved business entity)” registered in the storage area AR in the user information DB 18. For example, assume that of business entities which the user A has reserved by this time, the user A likes the business entity of “reserved business entity log 2” best and the business entity of “reserved business entity log 4” next.

In this case, the user A accesses the user information registration unit 15 of the center server 10 from the cellular phone 70 of his/her own through the cellular phone network 50 and Internet 20. The user inputs the user name and password and then sets priority “1” for “reserved business entity log 2 (reserved business entity 2)” in the storage area AR in the user information DB 18 and priority “2”for “reserved business entity log 4 (reserved business entity 4)” (FIG. 2C).

[Designation of Search Reject Business Entity]

The user A can designate whether to exclude “reserved business entity log (reserved business entity)” registered in the storage area AR in the user information DB 18 from vacancy information search targets. For example, assume that of business entities which the user A has reserved by this time, the user A feels like never visiting the business entities of “reserved business entity log 1 (reserved business entity 1)” and “reserved business entity log 3 (reserved business entity 3)” again.

In this case, the user A accesses the user information registration unit 15 of the center server 10 from the cellular phone 70 of his/her own through the cellular phone network 50 and Internet 20. The user inputs the user name and password and then designates the business entities of “reserved business entity log 1 (reserved business entity 1)” and “reserved business entity log 3 (reserved business entity 3)” as search reject business entities.

The user information registration unit 15 extracts the business entity codes of “reserved business entity log 1 (reserved business entity 1)” and “reserved business entity log 3 (reserved business entity 3)” from the storage area AR in the user information DB 18 and registers the extracted business entity codes as “search reject log 1 (search reject business entity 1)” and “search reject log 2 (search reject business entity 2)” (FIG. 2D).

In this embodiment, when “reserved business entity log” and “search reject log” are registered in the whole storage area AR in the user information DB 18, the user information registration unit 15 overwrites the logs in the chronological order.

[Business Entity Reservation: When Reserved Business Entities are Present]

Assume that the user A has reserved four business entities by this time and done priority setting and search reject business entity designation for the four reserved business entities so that the user information in the storage area AR in the user information DB 18 is in the registered state shown in FIG. 2D. In this state, the user A reserves a business entity by using the system.

In this case, the user A accesses the franchisee search unit 13 of the center server 10 from the cellular phone 70 of his/her own through the cellular phone network 50 and Internet 20. The user inputs the user name and password and inputs an instruction of business entity search. Upon receiving the business entity search instruction from the user A, the franchisee search unit 13 specifies the user code of the user A on the basis of the authenticated user name. The franchisee search unit 13 accesses the user information DB 18, refers to the user information in the storage area AR assigned to the user code, and searches for business entity vacancy information stored in the franchisee DB 17.

Business entity vacancy information is searched for by the following method.

The franchisee search unit 13 checks priority set for “reserved business entity log (reserved business entity)” registered in the storage area of the user A in the user information DB 18 and searches for vacancy information of the reserved business entity, which is stored in the franchisee DB 17, in the order of priorities. In this example, priority “1” is set for “reserved business entity log 2 (reserved business entity 2)” and “2” for “reserved business entity log 4 (reserved business entity 4)”. Hence, the vacancy information of the business entity is searched for in the order of “reserved business entity 2” and “reserved business entity 4”. The franchisee search unit 13 sends the search result to the cellular phone 70 of the user A. The user A makes a reservation for the desired business entity on the basis of the search result sent to the cellular phone 70, i.e., the vacancy information of “reserved business entity 2” or “reserved business entity 4”.

If all reserved business entities having set priorities have no free space, the franchisee search unit 13 searches for vacancy information of remaining business entities stored in the franchisee DB 17 and sends the search result to the cellular phone 70 of the user A. At this time, the franchisee search unit 13 refers to “search reject log (search reject business entity)” registered in the storage area AR of the user A in the user information DB 18 and excludes business entities registered in “search reject log (search reject business entity)” from vacancy information search targets. Vacancy information of a business entity designated by the user A as a business entity which he/she feels like visiting never again is not searched. Hence, the vacancy information search efficiency can be increased.

The user A makes a reservation for the desired business entity on the basis of the search result sent to the cellular phone 70. At this time, the user A can make the cellular phone 70 of his/her own display through the Internet 20 a video image sensed by the live camera 33 in the business entity 30 to be reserved. The user can obtain information which is not available from only character or still image data, including the condition of the table to be reserved, crowd in the business entity, and atmosphere in the business entity. Hence, he/she can make the reservation after confirming the state in the business entity in advance. The video image sensed by the live camera 33 can also be confirmed for “reserved business entity 2” or “reserved business entity 3” for which priority is set as described above. However, this function is particularly convenient for a new business entity the user has never visited.

A plurality of live cameras 33 may be provided in the business entity 30, and an image from a desired viewpoint may be selected on the cellular phone 70. When, for example, the live cameras 33 are attached to staff working in the business entity and connected to the personal computer 31 by a wireless LAN, conditions in the business entity can be grasped better. In addition, the business entity can demonstrate its motivation directly to the user before he/she comes. From the business entity owner side, the morale in the business entity can be heightened.

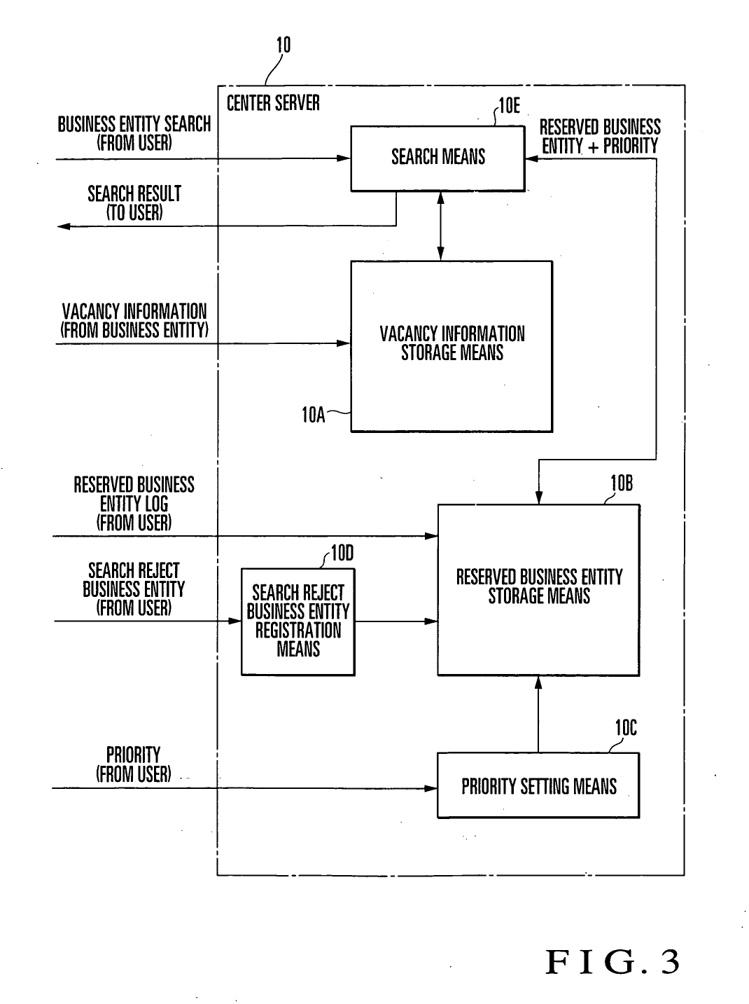

FIG. 3 shows the function of the main part of the center server 10 in this system. The center server 10 comprises a vacancy information storage means 10A for storing business entity vacancy information, a reserved business entity storage means 10B for storing the log of reserved business entities reserved by the user, a priority setting means 10C for setting priorities given by the user for reserved business entities stored in the reserved business entity storage means 10B, a search means 10E for accessing the vacancy information storage means 10A in response to a request from the user and searching for vacancy information of each reserved business entity of the user, which is stored in the reserved business entity storage means 10B, in the order of priorities set for the reserved business entities, and a search reject business entity registration means 10D for registering, of reserved business entities stored in the reserved business entity storage means 10B, a business entity designated by the user as a search reject business entity.

Referring to FIG. 3, the vacancy information storage means 10A corresponds to the franchisee DB 17 shown in FIG. 1. The reserved business entity storage means 10B corresponds to the user information DB 18. The priority setting means 10C and search reject business entity registration means 10D correspond to part of the function of the user information registration unit 15. The search means 10E corresponds to part of the function of the franchisee search unit 13.

In the above-described embodiment, the cellular phone has been described as an example of the terminal held by the user. However, vacancy information search can also be done from a PDA or personal computer in the same way as described above.

The user may want to go to another business entity than usual according to the mood of the moment. Hence, a function of validating or invalidating (new search) priority setting in searching vacancy information may be added.

As described above, according to the present invention, the system comprises the vacancy information storage means for storing business entity vacancy information, the reserved business entity storage means for storing the log of reserved business entities reserved by the user, the priority setting means for setting priority given by the user for reserved business entities stored in the reserved business entity storage means, and the search means for accessing the vacancy information storage means in response to a request from the user and searching for vacancy information of each reserved business entity of the user, which is stored in the reserved business entity storage means, in the order of priorities set for the reserved business entities. Hence, the log of reserved business entities reserved by the user is stored. Priorities given from the user are set for the stored reserved business entities. In response to the request from the user, vacancy information of each reserved business entity of the user is searched for in the order of priorities. With this arrangement, the user can immediately obtain vacancy information of favorite business entities and search for vacancy information of a desired business entity easily in a short time.

For example, if the user A has reserved two business entities so far, the reserved business entities are stored as the reserved business entities of the user A. The user A can set priorities for the reserved business entities of the user A. Assume that the user A sets priority “1” for the first reserved business entity and priority “2” for the second reserved business entity. In this case, in response to a request from the user A, vacancy information of each reserved business entity of the user A is searched for in the order of priorities “1” and “2”.

The system also comprises the means for registering, of reserved business entities stored in the reserved business entity storage means, a business entity designated by the user as a search reject business entity to be excluded from vacancy information search targets.

For example, assume that the user A has reserved four business entities so far, and the four reserved business entities are stored as the reserved business entities of the user A. When the user A designates two of the four reserved business entities as search reject business entities, the two designated business entities are excluded from vacancy information search targets. Since of the stored reserved business entities, the business entities designated by the user as search reject business entities are excluded from vacancy information search targets, vacancy information of each business entity the user wants to visit never again is not searched. Hence, the vacancy information search efficiency can be increased.

A camera is provided in the business entity, and a video image sensed by the camera in the business entity designated by the user is displayed on the terminal held by the user in response to a request from the user. The user can make the terminal of his/her own display the video image sensed by the camera in the desired business entity as needed. Hence, he/she can obtain information which is not available from only character or still image data, including the condition of the table to be reserved, crowd in the business entity, and atmosphere in the business entity, and make a reservation after confirming the state in the business entity in advance.

In business entity reservation by the user, if identical priorities are to be set for reserved business entities, the priority may be corrected to the subsequent number automatically, or the user may be informed of the duplication and correct it.

The user information DB is overwritten when no storage area remains. However, the user information DB may be reset appropriately by the user or automatically after the elapse of predetermined period.

1. A vacancy information search system comprising:
vacancy information storage means for storing business entity vacancy information;
reserved business entity storage means for storing a log of a business entity reserved by a user;
priority setting means for setting a priority given by the user for the reserved business entity stored in said reserved business entity storage means; and
search means for accessing said vacancy information storage means in response to a request from the user and searching for vacancy information of the reserved business entity of the user, which is stored in said reserved business entity storage means, in order of priorities set for the reserved business entity.

2. A system according to claim 1, further comprising means for registering, of reserved business entities stored in said reserved business entity storage means, a business entity designated by the user as a search reject business entity to be excluded from vacancy information search targets.

3. A system according to claim 1, further comprising
a camera which is provided in the business entity, and
means for displaying a video image sensed by said camera in the business entity designated by the user on a terminal held by the user.

4. A vacancy information search method comprising:
storing business entity vacancy information and a log of a reserved business entity reserved by a user in storage means, setting a priority given by the user for the reserved business entity stored in said storage means for storing the reserved business entity, accessing said storage means for storing business entity vacancy information in response to a request from the user, and searching for vacancy information of the reserved business entity of the user, which is stored in said storage means, in order of priorities set for the reserved business entity.

5. A method according to claim 4, further comprising registering, of reserved business entities stored in said storage means for storing the reserved business entity, a business entity designated by the user as a search reject business entity to be excluded from vacancy information search targets.

6. A method according to claim 4, further comprising providing a camera in the business entity, and displaying a video image sensed by the camera in the business entity designated by the user on a terminal held by the user.
